(19) United States
(12) Patent Application Publication
(10) Pub. No.: US 2018/0371249 A1
(43) Pub. Date: Dec. 27, 2018

(54) HIGH IMPACT STRENGTH POLYCARBONATE COMPOSITIONS FOR ADDITIVE MANUFACTURING

(71) Applicant: SABIC GLOBAL TECHNOLOGIES B.V., BERGEN OP ZOOM (NL)

(72) Inventors: Malvika Bihari, Evansville, IN (US); Sarah E. Grieshaber, Glenmont, NY (US)

(21) Appl. No.: 16/060,547

(22) PCT Filed: Dec. 9, 2016
(86) PCT No.: PCT/US2016/065697

§ 371 Date: Jun. 8, 2018

Related U.S. Application Data
(60) Provisional application No. 62/266,241, filed on Dec. 11, 2015.

(51) Int. Cl. C08L 83/10; C08G 81/00; C08L 69/00; C08K 5/13; B29C 64/118

(52) U.S. Cl. CPC C08L 83/10; C08G 81/00; C08G 77/448; C08K 5/13; B29C 64/118; C08L 69/00

(57) ABSTRACT

Provided herein are polycarbonate—polycarbonate-siloxane block copolymers, which compositions are useful in additive manufacturing applications. Additive manufactured articles made with the disclosed compositions exhibit mechanical properties that are greatly improved over existing additive manufactured polycarbonate articles, and additive manufactured articles made with the disclosed compositions exhibit mechanical properties that approach the corresponding properties of injection molded articles.

### RELATED APPLICATION

The present application claims priority to and the benefit of U.S. Patent Application No. 62/266,241, “High Impact Strength Polycarbonate Compositions for Additive Manufacturing” (filed Dec. 11, 2015), the entirety of which application is incorporated herein by reference for any and all purposes.

### TECHNICAL FIELD

The present disclosure relates to the field of additive manufacturing and to the field of polycarbonate materials.

### BACKGROUND

Fused filament fabrication (FFF) is an additive manufacturing technology that uses thermoplastic monofilaments, pellets, or metal wires to build parts or articles in a layer by layer manner. In some embodiments, material from a spool is fed by an extrusion nozzle that is heated to melt the material, which melted material is then deposited by a controlled mechanism in horizontal and vertical directions. Commonly used polymeric materials in the FFF process are styrenic polymers like acrylonitrile-butadiene-styrene (ABS) and blends with other polymers, polycarbonate (PC), polyetherimide (PEI) and polyphenylsulphones (PPS).

Polycarbonates are known to have high impact strength among various thermoplastics. As one example, injection molded PC has a notched Izod impact strength of 600-800 J/m (Joules/meter). But PC parts printed by FFF process may lack impact strength; currently available PC materials exhibit an Izod notched impact strength of 30-70 J/m, which strength is comparatively low compared to the strength observed in injection molded parts. This relatively reduced strength in turn limits the applications to which additive-manufactured parts can be put. Accordingly, there is a long-felt need in the art for additive manufacturing materials and methods that give rise to additive-manufactured articles having improved mechanical properties. There is also a long-felt need for related methods.

### SUMMARY

In meeting the described long-felt needs, the present disclosure provides polymeric compositions for additive manufacturing, comprising: an amount of a polycarbonate composition comprising: an amount of a BPA-polycarbonate and further comprising (a) an amount of a BPA-polycarbonate-siloxane block copolymer having a molecular weight (weight average) of from about 28,000 to about 32,000 Da, (b) an amount of a BPA-polycarbonate-siloxane block copolymer having a molecular weight (weight average) of from about 22,500 to about 23,500 Da, or both (a) and (b), and, optionally, the BPA-polycarbonate of the polycarbonate composition having a molecular weight (weight average) in the range of from about 16,000 to about 35,000 Da, the polymeric composition being in pellet or filament form. (All molecular weights are measured by gel permeation chromatography and calibrated with polycarbonate standards.)

Also provided are methods of fabricating an additive-manufactured article, comprising: heating a working amount of a polymeric composition according to the present disclosure to a molten state; controllably dispensing at least some of the working amount of the polymeric composition onto a substrate; and effecting solidification of the dispensed amount of the polymeric composition.

Additionally disclosed are additive manufactured articles made according to the present disclosure.

Also provided are systems, comprising: a dispenser having disposed within an amount of the polymeric composition of the present disclosure; and a substrate, one or both of the dispenser and substrate being capable of controllable motion relative to the other.

### BRIEF DESCRIPTION OF THE DRAWINGS

The summary, as well as the following detailed description, is further understood when read in conjunction with the appended drawings. For the purpose of illustrating the technology, there are shown in the drawings exemplary and preferred embodiments of the invention; however, the disclosure is not limited to the specific methods, compositions, and devices disclosed. In addition, the drawings are not necessarily drawn to scale. In the drawings:

FIG. 1 depicts exemplary FFF part orientations (upright, on edge, and flat) with reference to X, Y, and Z axes; as shown, parts may be built in the XY (flat), XZ (on edge), or ZX (upright) orientations; and

FIG. 2 provides a typical filament (raster) fill pattern for each layer of a part (applicable to all print orientations).

### DETAILED DESCRIPTION OF ILLUSTRATIVE EMBODIMENTS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps. It is to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams (g) to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

Weight percentages should be understood as not exceeding a combined weight percent value of 100 wt. %. Where a standard is mentioned and no date is associated with that standard, it should be understood that the standard is the most recent standard in effect on the date of the present filing.

Aspect 1. A polymeric composition for additive manufacturing, comprising: an amount of a polycarbonate composition comprising: an amount of a BPA-polycarbonate and further comprising (a) an amount of a BPA-polycarbonate-siloxane block copolymer having a molecular weight (weight average) of from about 28,000 to about 32,000 Da measured by gel permeation chromatography and calibrated with polycarbonate standards, (b) an amount of a BPA-polycarbonate-siloxane block copolymer having a molecular weight (weight average) of from about 22,500 to about 23,500 Da measured by gel permeation chromatography and calibrated with polycarbonate standards, or both (a) and (b), and the BPA-polycarbonate of the polycarbonate composition optionally having a molecular weight (weight average) in the range of from about 16,000 to about 35,000 Da measured by gel permeation chromatography and calibrated with polycarbonate standards.

The BPA-polycarbonate-siloxane block copolymer may have a molecular weight (weight average) of about 28,000, about 29,000, about 30,000, about 31,000, or even about 32,000 Da. The BPA-polycarbonate-siloxane block copolymer may also have a molecular weight (weight average) of about 22,500, about 23,000, or even about 23,500 Da. The disclosed filaments and pellets may, in some embodiments, include BPA-polycarbonate-siloxane block copolymers having molecular weights in both of the foregoing ranges.

One exemplary such polycarbonate composition is shown below by formula (I), which shows one illustrative carbonate block (left) and one illustrative siloxane block (right):

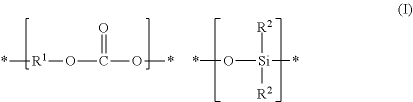

Suitable R1 and R2 species are described below.

Polycarbonates are known to those of skill in the art. Polycarbonates, including aromatic carbonate chain units, include compositions having structural units of the formula (II):

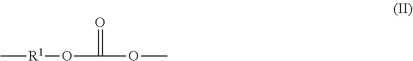

in which the R¹ groups are aromatic, aliphatic or alicyclic radicals. Preferably, R¹ is an aromatic organic radical, e.g., a radical of the formula (III):

-A¹-Y¹-A²- (III)

wherein each of A₁ and A₂ is a monocyclic divalent aryl radical and Y1 is a bridging radical having zero, one, or two atoms which separate A1 from A2. In an exemplary embodiment, one or more atoms separate A1 from A2. Illustrative examples of radicals of this type are —O—, —S(O)—, —S(O₂)—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, or the like. In another embodiment, zero atoms separate A1 from A2, with an illustrative example being bisphenol. The bridging radical Y1 can be a hydrocarbon group or a saturated hydrocarbon group such as methylene, cyclohexylidene or isopropylidene.

Polycarbonates can be produced by, e.g., melt processes and also by interfacial reaction polymer processes, both of which are well known in the art. An interfacial process may use precursors such as dihydroxy compounds in which only one atom separates A¹ and A². As used herein, the term “dihydroxy compound” includes, for example, bisphenol compounds having the general formula (IV) as follows:

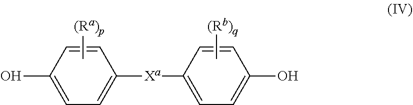

wherein R^{a} and R^{b} each independently represent hydrogen, a halogen atom, or a monovalent hydrocarbon group; p and q are each independently integers from 0 to 4; and X^{a} represents one of the groups of formula (V):

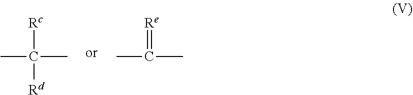

wherein R^{e} and R^{d} each independently represent a hydrogen atom or a monovalent linear or cyclic hydrocarbon group, and R^{e} is a divalent hydrocarbon group.

Examples of the types of bisphenol compounds that can be represented by formula (IV) include the bis(hydroxyaryl)alkane series. Other bisphenol compounds that can be represented by formula (IV) include those where X is —O—, —S—, —SO— or —SO22-.Other bisphenol compounds that can be utilized in the polycondensation of polycarbonate are represented by the formula (VI)

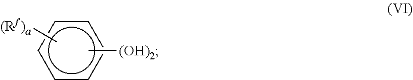

wherein, IV, is a halogen atom of a hydrocarbon group having 1 to 10 carbon atoms or a halogen substituted hydrocarbon group; n is a value from 0 to 4. When n is at least 2, R^{f} can be the same or different. Examples of bisphenol compounds represented by formula (V), are resorcinol, substituted resorcinol compounds such as 3-methyl resorcin, and the like.

Bisphenol compounds (e.g., bisphenol A), such as 2,2,2′,2′-tetrahydro-3,3,3′,3′-tetramethyl-1,1′-spirobi-[1H-indene]-6,6′-diol represented by the following formula (VII) can also be used.

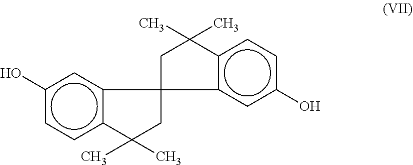

Branched polycarbonates, as well as blends of linear polycarbonate and a branched polycarbonate can also be used. Branched polycarbonates can be prepared by adding a branching agent during polymerization. These branching agents can include polyfunctional organic compounds containing at least three functional groups, which can be hydroxyl, carboxyl, carboxylic anhydride, haloformyl, and combinations including at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, benzophenone tetracarboxylic acid, or the like, or combinations including at least one of the foregoing branching agents. The branching agents can be added at a level of about 0.05 to about 2.0 weight percent (wt %), based upon the total weight of the polycarbonate in a given layer.

In one embodiment, the polycarbonate can be produced by a melt polycondensation reaction between a dihydroxy compound and a carbonic acid diester. Polycarbonate may also be end-capped.

Preferably, the weight average molecular weight of a polycarbonate is about 3,000 to about 1,000,000 grams/mole (g/mole). Within this range, it may be desirable to have a weight average molecular weight of greater than or equal to about 10,000, preferably greater than or equal to about 20,000, and more preferably greater than or equal to about 25,000 g/mole. Also desirable is a weight average molecular weight of less than or equal to about 100,000, preferably less than or equal to about 75,000, more preferably less than or equal to about 50,000, and most preferably less than or equal to about 35,000 g/mole.

A polysiloxane block may comprise repeating units having the structure

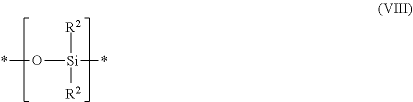

wherein each occurrence of R² is independently C₁-C₁₂ hydrocarbyl; and a surface modifying agent comprising at least one polysiloxane segment. A “polysiloxane segment” is defined as a monovalent or divalent polysiloxane moiety comprising at least three of the repeating units defined above. The polysiloxane segment preferably comprises at least five repeating units, more preferably at least 10 repeating units. In one embodiment, each occurrence of R² is methyl.

In one embodiment, the polysiloxane block has the structure

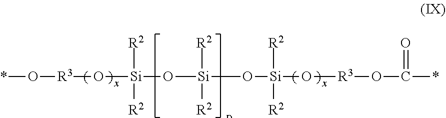

wherein each occurrence of R2 is independently C1-C12 hydrocarbyl; each occurrence of R3 is independently C6-C30 hydrocarbylene; x is 0 or 1; and D is about 5 to about 120. Within this range, the value of D may specifically be at least 10. Also within this range, the value of D may specifically be up to about 100, more specifically up to about 75, still more specifically up to about 60, even more specifically up to about 30. In one embodiment, x is 0 and each occurrence of R3 independently has the structure

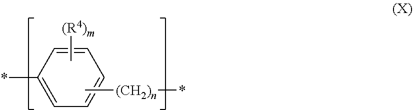

wherein each occurrence of R⁴ is independently halogen, C₁-C₈ hydrocarbyl, or C₁-C₈hydrocarbyloxy; m is 0 to 4; and n is 2 to about 12. A hydrogen atom occupies any phenylene ring position not substituted with R⁴. In another embodiment, each occurrence of R³ independently is a C₆-C₃₀ arylene radical that is the residue of a diphenol.

Suitable polysiloxane blocks also include those described in U.S. Pat. No. 4,746,701 to Kress et al., and U.S. Pat. No. 5,502,134 to Okamoto et al. Specifically, the polysiloxane block may be derived from a polydiorganosiloxane having the structure defined in U.S. Pat. No. 4,746,701 to Kress et al. at column 2, lines 29-48:

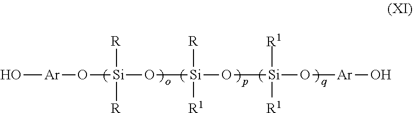

wherein the radicals Ar are identical or different arylene radicals from diphenols with preferably 6 to 30 carbon atoms; R and R¹ are identical or different and denote linear alkyl, branched alkyl, halogenated linear alkyl, halogenated branched alkyl, aryl or halogenated aryl, but preferably methyl, and the number of the diorganosiloxy units (the sum o+p+q) is about 5 to about 120. The polysiloxane block may also be derived from the polydimethylsiloxane defined in

U.S. Pat. No. 5,502,134 to Okamoto et al. at column 4, lines 1-9:

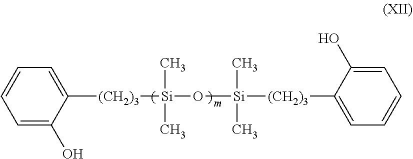

wherein m is about 5 to about 120.

In one embodiment, the polycarbonate-polysiloxane block copolymer consists essentially of the BPA-polycarbonate blocks and the polysiloxane blocks. The phrase “consists essentially of” does not exclude end groups derived from a chain terminator, such as phenol, tert-butyl phenol, para-cumyl phenol, or the like.

As explained above, a variety of PC-siloxane block copolymers are suitable for the disclosed technology. Exemplary PC-siloxane block copolymers are described in the following United States patents and patent applications, the entireties of which are incorporated herein by reference for any and all purposes: U.S. Pat. No. 5,455,310; U.S. Pat. No. 8,466,249; U.S. Pat. No. 5,530,083; U.S. Pat. No. 6,630,525, U.S. Pat. No. 3,751,519; U.S. Pat. No. 7,135,538; and US 2014/0234629.

The composition may be present in a spool or other filament form applicable to additive manufacturing. The composition is then heated so as to place the composition into molten form, and the additive manufacturing system then dispenses the molten composition at the desired location. The composition may also be present in pellet form. As described elsewhere herein, pellet-based additive manufacturing processes are also suitable.

Aspect 2. The polymeric composition of aspect 1, wherein the BPA-polycarbonate-siloxane block copolymer comprises from about 0.1 to about 99.9% of the weight of the polycarbonate and BPA-polycarbonate-siloxane block copolymer in the polycarbonate composition.

For example, the BPA-polycarbonate-siloxane block copolymer may comprise from about 1 to about 99 wt %, from 5 to about 90 wt %, from 15 to about 85 wt %, from 20 to about 80 wt %, from about 25 to about 75 wt %, from about 30 to about 70 wt %, from about 35 to about 65 wt %, from about 40 to about 60 wt %, from about 45 to about 55 wt %, or even about 50 wt % of the weight of the BPA-polycarbonate and BPA-polycarbonate-siloxane block copolymer in the polycarbonate composition. A range of from about 15 to about 85 wt % is considered especially suitable, e.g., about 15, 20, 25, 30, 35, 40, 45, 50, 55, 60, 65, 70, 75, 80 or even about 85 wt %.

Aspect 3. The polymeric composition of any of aspects 1-2, wherein the weight of the polysiloxane is from about 0.1 to about 99.9 wt % of the weight of the BPA-polycarbonate-siloxane block copolymer in the polycarbonate composition.

For example, the polysiloxane may comprise from about 1 to about 99 wt %, from 5 to about 90 wt %, from 15 to about 85 wt %, from 20 to about 80 wt %, from about 25 to about 75 wt %, from about 30 to about 70 wt %, from about 35 to about 65 wt %, from about 40 to about 60 wt %, from about 45 to about 55 wt %, or even about 50 wt % of the weight of the BPA-polycarbonate-siloxane block copolymer in the polycarbonate composition. Ranges of from about 6 to about 20 wt % (e.g., about 6, 7, 8, 9, 10, 11, 12, 13, 14, 15, 16, 17, 18, 19, and 20 wt %) are considered especially suitable.

Aspect 4. The polymeric composition of any of aspects 1-3, wherein the BPA-polycarbonate-siloxane block copolymer has a molecular weight (weight average) of from about 28,000 to about 32,000 Da and comprises from about 10 to about 40 wt % (e.g., about 10, 11, 12, 13, 14, 15, 16, 17, 18, 19, 20, 21, 22, 23, 24, 25, 26, 27, 28, 29, 30, 31, 32, 33, 34 35, 36, 37, 38, 39, or about 40%) of the weight of the BPA-polycarbonate and BPA-polycarbonate-siloxane block copolymer in the polycarbonate composition.

Aspect 5. The polymeric composition of aspect 4, wherein the BPA-polycarbonate-siloxane block copolymer has a Mw (weight average) of from about 28,000 to about 32,000 Da and comprises from about 15 to about 25 wt % of the weight of the BPA-polycarbonate and BPA-polycarbonate-siloxane block copolymer in the polycarbonate composition.

Aspect 6. The polymeric composition of any of aspects 1-5, wherein the BPA-polycarbonate-siloxane block copolymer has a Mw (weight average) of from about 22,500 to about 23,500 Da and comprises from about 30 to about 90 wt % (e.g., from about 75 to about 85 wt %) of the weight of the BPA-polycarbonate and BPA-polycarbonate-siloxane block copolymer in the polycarbonate composition.

Aspect 7. The polymeric composition of any of aspects 1-6, wherein the weight of the polysiloxane is from about 1 to about 7 wt % of the polycarbonate composition, e.g, about 1, 2, 3, 4, 5, 6, or even about 7 wt % of the polycarbonate composition.

The polysiloxane block of the BPA-polycarbonate-siloxane block copolymer may have an average block length of from about 10 to about 100, e.g., about 10, 15, 20, 25, 30, 35, 40, 45, 50, 55, 60, 65, 70, 75, 80, 85, 90, 95, or about 100. The copolymer may have an average polysiloxane block length of about 10 to about 100.

Block lengths of from about 40 to about 50 units (e.g., about 45) are considered especially suitable. It should be understood that a copolymer may include blocks that are all the same size, but a copolymer may also include blocks of different sizes.

As two illustrative examples, a PC-siloxane block copolymer with 6 wt % siloxane (block length appx. 45) is considered suitable. Likewise, a PC-siloxane block copolymer with 20 wt % siloxane (block length appx. 45) is also considered suitable.

Aspect 8. The polymeric composition of any of aspects 1-7, wherein the polycarbonate composition has one or more of:

(a) a Notched Izod Impact Strength measured at −40 deg. C that is within about 20% of the Notched Izod Impact Strength measured at 23 deg. C.

(b) an Un-Notched Izod Impact Strength measured at −40 deg. C that is within about 20% of the Un-Notched Izod Impact Strength measured at 23 deg. C.

(c) a Notched Izod Impact Strength measured at 23 deg. C that is from about 1.5 times to about 10 times (e.g., about 1.5, 2, 2.5, 3, 3.5, 4, 4.5, 5, 5.5, 6, 6.5, 7, 7.5, 8.5, 9, 9.5, or about 10 times)the Notched Izod Impact Strength measured at 23 deg. C of a BPA-polycarbonate that comprises about. 90 wt % end-capped PC with a molecular weight (weight average) of about 21,900 Daltons and about 10 wt % end-capped BPA-polycarbonate with a molecular weight (weight average) of about 29,900 Daltons.

(d) an Un-Notched Izod Impact Strength measured at 23 deg. C that is from about 1.5 times to about 10 times (e.g., about 1.5, 2, 2.5, 3, 3.5, 4, 4.5, 5, 5.5, 6, 6.5, 7, 7.5, 8.5, 9, 9.5, or about 10 times) the Un-Notched Izod Impact Strength measured at 23 deg. C (ASTM D256) of a BPA-polycarbonate that comprises about 90 wt % end-capped PC with a molecular weight (weight average) of about 21,900 Daltons and about 10 wt % end-capped BPA-polycarbonate with a molecular weight (weight average) of about 29,900 Daltons.

The foregoing characteristics (e.g., (c) and (d)) may be suitably evaluated on, e.g., comparative parts printed on a Fortus 400 MC™ or 900 MC™ printer in an on-edge (XZ) print orientation under standard polycarbonate conditions and measured using the ASTM D256 test protocol, at a model temperature of 345 deg. C., at an oven temperature of about 140 deg. C, using a tip size of 0.010″ (T16), a layer thickness (resolution) of 0.010″ (T16), a contour and raster width of 0.020″, a precision of the greater of +/−0.005″ or +/−0.0015″/″, a speed of about 12 in./sec, and an air gap of from −0.0010″ to 0.0000″. It should be understood that the foregoing is an exemplary measurement method only and does not limit the scope of the present disclosure.

The foregoing characteristics may be evaluated on parts printed by fused filament fabrication in an on-edge (XZ) print orientation under nominal conditions and measured using the ASTM D256 test protocol. By nominal conditions is meant conditions (temperature, humidity, print head speed) recommended for use with the material and manufacturing apparatus being used. As one example, a user using a Fortus 400 MC™ or 900 MC™ printer to print a material that comprises polycarbonate may operate the printer under standard polycarbonate conditions recommended, e.g., by the supplier of the printer and/or polycarbonate material for that printer/material combination.

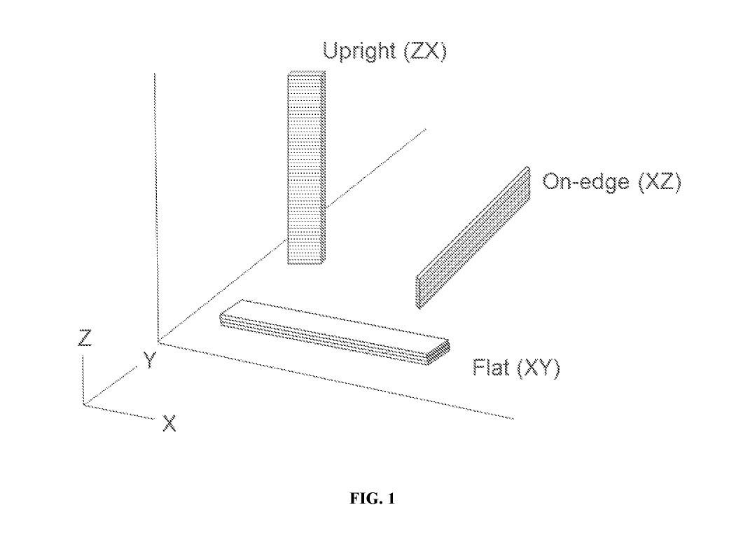

FIG. 1 provides an illustration of various print orientations for additive-manufactured articles, showing the positions of the component layers in various print orientations.

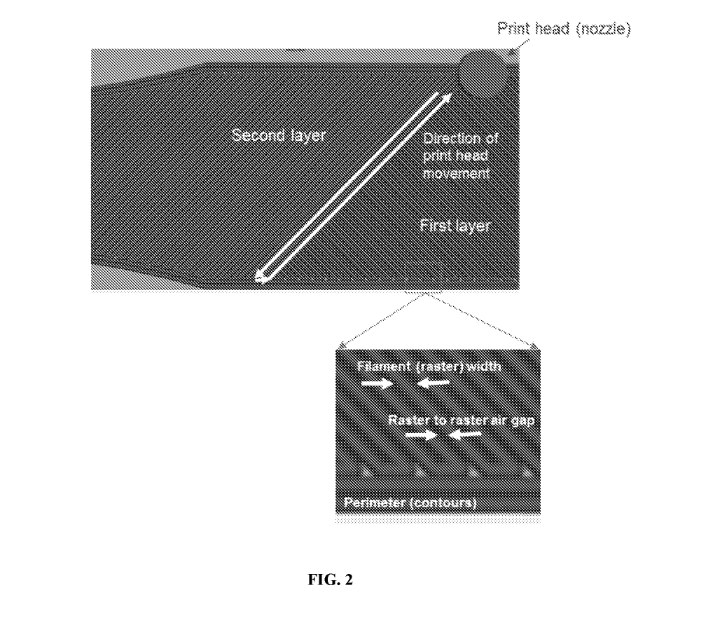

FIG. 2 provides an exemplary filament (raster) fill pattern for a part layer made by a filament-based additive manufacturing process; this pattern may apply to any print orientation. The parameters shown in FIG. 2 are known to those of skill in the art.

In FIG. 2, layer thickness (not labeled) is the thickness of the layer deposited by the nozzle. Raster angle (not shown) is the direction of raster with respect to the loading direction of stress. Raster-to-raster air gap is the distance between two adjacent deposited filaments in the same layer. The perimeter (contours) is the number of filaments deposited along the outer edge of a part. Filament (raster) width is the width of the filament deposited by the nozzle. The print head may operate such that the print head changes its angle of travel with each successive layer, e.g., by 45 degrees with each successive layer, such that roads on successive layers are criss-crossed relative to one another.

Aspect 9. The polymeric composition of any of aspects 1-8, wherein the polycarbonate composition is characterized as having a total multi-axial impact energy that is from about 1.5 times to about 10 times (e.g., about 1.5, 2, 2.5, 3, 3.5, 4, 4.5, 5, 5.5, 6, 6.5, 7, 7.5, 8.5, 9, 9.5, or about 10 times) the multi-axial impact energy of a BPA-polycarbonate that comprises about. 90 wt % end-capped BPA-polycarbonate with a Mw (weight average) of about 21,900 Daltons and about 10 wt % end-capped BPA-polycarbonate with a Mw (weight average) of about 29,900 Daltons.

The foregoing multi-axial impact energy characteristics in Aspect 9 may be suitably evaluated on, e.g., parts printed on Fortus 400 MC™ or 900 MC™ printer in an on-edge (XZ) print orientation under standard PC conditions and measured using ASTM D3763 test protocol, at a model temperature of 345 deg. C., at an oven temperature of about 140 deg. C, using a tip size of 0.010″ (T16), a layer thickness (resolution) of 0.010″ (T16), a contour and raster width of 0.020″, and a speed of about 12 in./sec.

As mentioned elsewhere herein, the foregoing characteristics may be evaluated on parts printed by fused filament fabrication in an on-edge (XZ) print orientation under nominal conditions and measured using the ASTM D3763 test protocol. By nominal conditions is meant conditions (temperature, humidity, print head speed) recommended for use with the material and manufacturing apparatus being used. As one example, a user using a Fortus 400 MC™ or 900 MC™ printer to print a material that comprises polycarbonate may operate the printer under standard polycarbonate conditions recommended, e.g., by the supplier of the printer and/or polycarbonate material for that printer/material combination.

Aspect 10. The polymeric composition of any of aspects 1-9, wherein the composition is in the form of a filament, the filament having a length of at least 1 cm, and the standard deviation of the filament's diameter along 0.5 cm of the length being less than about 0.1 mm.

Aspect 11. The polymeric composition of aspect 10, wherein the filament is in coiled form. A filament may be present on a spool, a core, reel, or otherwise packaged.

Aspect 12. The polymeric composition of any of aspects 1-11, wherein the composition is in the form of a pellet, the pellet comprising a cross-sectional dimension (e.g., diameter, length, width, thickness) in the range of from about 0.1 mm to about 50 mm (e.g., about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or even about 50 mm), an aspect ratio in the range of from about 1 to about 10, or any combination thereof.

Aspect 13. A method of fabricating an additive-manufactured article, comprising: additively manufacturing an article using the composition of any of aspects 1-12.

As one example, an additive manufacturing method of forming a three dimensional object may include, e.g., depositing a layer of thermoplastic material (e.g., the disclosed compositions) through a nozzle on to a platform to form a deposited layer; depositing a subsequent layer onto the deposited layer; and repeating the preceding steps to form the three dimensional object.

Apparatuses for forming three dimensional object are described elsewhere herein and may comprise, e.g., a platform configured to support the three-dimensional object; an extrusion head arranged relative to the platform and configured to deposit a thermoplastic material in a preset pattern to form a layer of the three-dimensional object; a controller configured to control the position of the extrusion head and the energy source relative to the platform. In some embodiments, a vertical distance between the platform and the extrusion head is adjustable. (The platform may be heated, cooled, or maintained at ambient temperature.)

In some embodiments, the method may comprise heating a working amount of a polymeric composition according to any of aspects 1-12 to a molten state; controllably dispensing at least some of the working amount of the polymeric composition onto a substrate; and effecting solidification of the dispensed amount of the polymeric composition.

Aspect 14. The method of aspect 13, wherein the substrate comprises an amount of the polymeric composition of any of aspects 1-12. For example, in an additive-manufacturing process, a first amount of the polymeric composition is dispensed to a substrate, following which a second amount of the polymeric composition is dispensed atop the first amount of the polymeric composition. The additive manufacturing process may comprise, e.g., fused filament fabrication, large format additive manufacturing, or any combination thereof.

Aspect 15. The method of any of aspects 13-14, wherein the dispensing is effected by relative motion between the dispenser and the substrate. This may be accomplished by systems known in the art, e.g., systems in which an extrusion head or other dispenser may move along one, two, or three axes, as well as be rotatable. (A substrate may also move in one, two, or three dimensions as well, and may also be rotatable.)

Aspect 16. The method of aspect 15, wherein the dispenser is adapted to dispense molten polymeric feedstock from at least one of pellet and filament forms.

The dispensing may be effected by a nozzle, spinneret, or other dispenser, which dispenser may be adapted to move in one, two, or even three dimensions. The substrate onto which the dispenser dispenses the composition may also be adapted to move in one, two, or three dimensions. The movement of the dispenser, substrate, or both, is suitably according to a preset schedule, e.g., a schedule of locations and dispensation amounts described in a data file that governs the movement of the dispenser and/or substrate as well as any of the timing, amount, and/or type of material dispensed.

Aspect 17. The method of any of aspects 13-16, wherein the dispensed amount of the polymeric feedstock, following solidification, is characterized as attached to the substrate.

Aspect 18. An additive manufactured article, made according to any of aspects 13-17. An additively-manufactured article will suitably comprise multiple layers.

Layers within articles can be, e.g., of any thickness suitable for the user's additive manufacturing process. The plurality of layers may each be, on average, preferably at least 50 micrometers (microns) thick, more preferably at least 80 microns thick, and even more preferably at least 100 micrometers (microns) thick. In one preferred embodiment, the plurality of sintered layers are each, on average, preferably less than 500 micrometers (microns) thick, more preferably less than 300 micrometers (microns) thick, and even more preferably less than 200 micrometers (microns) thick. Accordingly, layers may be, e.g., 50-500, 80-300, or 100-200 micrometers (microns) thick. Articles produced via a filament-based deposition process may, of course, have layer thicknesses that are the same or different from those described above, and the thicknesses of different layers in an article may differ from one another.

Some illustrative articles include, e.g., mobile/smart phones (covers and components), helmets, automotive, outdoor electrical enclosures, and medical devices; as described elsewhere herein, the disclosed technology is particularly suitable for applications that require a relatively high impact strength. Other illustrative articles include housings for gaming systems, smart phones, GPS devices, computers (portable and fixed), e-readers, copiers, goggles, and eyeglass frames. Other suitable articles include electrical connectors, and components of lighting fixtures, ornaments, home appliances, construction, Light Emitting Diodes (LEDs), and the like.

In some embodiments, the disclosed technology can be used to form articles such as printed circuit board carriers, burn in test sockets, flex brackets for hard disk drives, and the like. Electronic applications are particularly suitable, e.g., articles related to electric vehicle charging systems, photovoltaic junction connectors, and photovoltaic junction boxes.

Further non-limiting example articles include, without limitation, light guides, light guide panels, lenses, covers, sheets, films, and the like, e.g., LED lenses, LED covers, and the like. As one example, a housing (e.g., an LED housing) formed according to the present disclosure may be used in aviation lighting, automotive lighting, (e.g., brake lamps, turn signals, headlamps, cabin lighting, and indicators), traffic signals, text and video displays and sensors, a backlight of the liquid crystal display device, control units of various products (e.g., for televisions, DVD players, radios, and other domestic appliances), and a dimmable solid state lighting device.

Other articles include, for example, hollow fibers, hollow tubes, fibers, sheets, films, multilayer sheets, multilayer films, molded parts, extruded profiles, coated parts, foams, windows, luggage racks, wall panels, chair parts, lighting panels, diffusers, shades, partitions, lenses, skylights, lighting devices, reflectors, ductwork, cable trays, conduits, pipes, cable ties, wire coatings, electrical connectors, air handling devices, ventilators, louvers, insulation, bins, storage containers, doors, hinges, handles, sinks, mirror housing, mirrors, toilet seats, hangers, coat hooks, shelving, ladders, hand rails, steps, carts, trays, cookware, food service equipment, communications equipment and instrument panels.

Articles may be used in a variety of applications. An article may be characterized as an aircraft component, a medical device, a tray, a container, a laboratory tool, a food- or beverage-service article, an automotive component, a construction article, a medical implant, a housing, a connector, an ornament, or any combination thereof.

Aspect 19. A system (suitably an additive manufacturing system), comprising: a dispenser having disposed within an amount of the polymeric composition of any of aspects 1-12; and a substrate, one or both of the dispenser and substrate being capable of controllable motion relative to the other.

Aspect 20. The system of aspect 19, wherein the dispenser is configured to render molten and dispense the composition.

Suitable additive manufacturing processes include those processes that use filaments, pellets, and the like, and suitable processes will be known to those of ordinary skill in the art; the disclosed compositions may be used in virtually any additive manufacturing process that uses filament or pellet build material.

Although additive manufacturing techniques are known to those in the art, the present disclosure will provide additional information on such techniques for the sake of convenience.

In some additive manufacturing techniques, a plurality of layers is formed in a preset pattern by an additive manufacturing process. “Plurality” as used in the context of additive manufacturing includes 2 or more layers. The maximum number of layers can vary and may be determined, for example, by considerations such as the size of the article being manufactured, the technique used, the capabilities of the equipment used, and the level of detail desired in the final article. For example, 20 to 100,000 layers can be formed, or 50 to 50,000 layers can be formed.

As used herein, “layer” is a term of convenience that includes any shape, regular or irregular, having at least a predetermined thickness. In some embodiments, the size and configuration of two dimensions are predetermined, and on some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments, the thickness of each layer as formed is 0.1 millimeters (mm) to 5 mm. In other embodiments, the article is made from a monofilament additive manufacturing process. For example, the monofilament may comprise a thermoplastic polymer with a diameter of from 0.1 to 5.0 mm.

The preset pattern can be determined from a three-dimensional digital representation of the desired article as is known in the art and described in further detail below. Such a representation may be created by a user, or may be based—at least in part—on a scan made of a three-dimensional real object.

Any additive manufacturing process can be used, provided that the process allows formation of at least one layer of a thermoplastic material that is fusible to the next adjacent layer. The plurality of layers in the predetermined pattern may be fused to provide the article. Any method effective to fuse the plurality of layers during additive manufacturing can be used. In some embodiments, the fusing occurs during formation of each of the layers. In some embodiments the fusing occurs while subsequent layers are formed, or after all layers are formed.

In some embodiments, an additive manufacturing technique known generally as material extrusion can be used. In material extrusion, an article can be formed by dispensing a material (“the build material”, which may be rendered flowable) in a layer-by-layer manner and fusing the layers. “Fusing” as used herein includes the chemical or physical interlocking of the individual layers, and provides a “build structure.” Flowable build material can be rendered flowable by dissolving or suspending the material in a solvent. In other embodiments, the flowable material can be rendered flowable by melting. In other embodiments, a flowable prepolymer composition that can be crosslinked or otherwise reacted to form a solid can be used. Fusing can be by removal of the solvent, cooling of the melted material, or reaction of the prepolymer composition.

In one particular embodiment, an article may be formed from a three-dimensional digital representation of the article by depositing the flowable material as one or more roads on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build material.”

In some embodiments, a support material as is known in the art can optionally be used to form a support structure. In these embodiments, the build material and the support material can be selectively dispensed during manufacture of the article to provide the article and a support structure. The support material can be present in the form of a support structure, for example, a so-called scaffolding that may be mechanically removed or washed away when the layering process is completed to a desired degree. The dispenser may be movable in one, two, or three dimensions, and may also be rotatable. Similarly, the substrate may also be movable in one, two, or three dimensions, and may also be rotatable.

Systems for material extrusion are known. One exemplary material extrusion additive manufacturing system includes a build chamber and a supply source for the thermoplastic material. The build chamber may include a build platform, a gantry, and a dispenser for dispensing the thermoplastic material, for example an extrusion head.

The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other.

Alternatively, the platform can be configured to move in the horizontal x-y plane and the extrusion head can be configured to move along the z-axis. Other similar arrangements can also be used such that one or both of the platform and extrusion head are movable relative to each other. The build platform can be isolated or exposed to atmospheric conditions. The distance between the platform and head may be adjustable, as may be the orientation of the head and platform relative to one another. It should be understood that the platform may be heated, cooled or maintained at ambient temperature, depending on the user's needs.

In some embodiments, both the build structure and the support structure of the article formed can include a fused expandable layer. In other embodiments, the build structured includes a fused expandable layer and the support material does not include an expandable layer. In still other embodiments, the build structure does not include an expandable layer and the support structure does include a fused expandable layer. In those embodiments where the support structure includes an expandable layer, the lower density of the expanded layer can allow for the support material to be easily or more easily broken off than the non-expanded layer, and re-used or discarded.

In some embodiments, the support structure can be made purposely breakable, to facilitate breakage where desired. For example, the support material may have an inherently lower tensile or impact strength than the build material. In other embodiments, the shape of the support structure can be designed to increase the breakability of the support structure relative to the build structure.

For example, in some embodiments, the build material can be made from a round print nozzle or round extrusion head. A round shape as used herein means any cross-sectional shape that is enclosed by one or more curved lines. A round shape includes circles, ovals, ellipses, and the like, as well as shapes having an irregular cross-sectional shape. Three dimensional articles formed from round shaped layers of build material can possess strong structural strength. In other embodiments, the support material for the articles can be can made from a non-round print nozzle or non-round extrusion head. A non-round shape means any cross-sectional shape enclosed by at least one straight line, optionally together with one or more curved lines. A non-round shape can include squares, rectangles, ribbons, horseshoes, stars, T-head shapes, X-shapes, chevrons, and the like. These non-round shapes can render the support material weaker, brittle and with lower strength than round shaped build material.

The above material extrusion techniques include techniques such as fused deposition modeling and fused filament fabrication as well as others as described in ASTM F2792-12a. In fused material extrusion techniques, an article can be produced by heating a thermoplastic material to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted thermoplastic material fuses to the previously deposited layer, and solidifies upon a drop in temperature. Extrusion of multiple subsequent layers builds the desired shape. In some embodiments at least one layer of an article is formed by melt deposition, and in other embodiments, more than 10, or more than 20, or more than 50 of the layers of an article are formed by melt deposition, up to and including all of the layers of an article being formed by melt deposition.

In some embodiments the thermoplastic polymer is supplied in a melted form to the dispenser. The dispenser can be configured as an extrusion head. The extrusion head can deposit the thermoplastic composition as an extruded material strand to build the article. Examples of average diameters for the extruded material strands can be from 1.27 millimeters (0.050 inches) to 3.0 millimeters (0.120 inches). The foregoing dimensions are exemplary only and do not serve to limit the scope of the present disclosure.

So-called large format additive manufacturing (LFAM) systems are also within the scope of the present disclosure, as such systems may utilize pellets of polymeric material according to the present disclosure to form parts.

In a LFAM system, a comparatively large extruder converts pellets to a molten form that are then deposited on a table. A LFAM system may comprise a frame or gantry that in turn includes a print head that is movable in the x,y and/or z directions. (The print head may also be rotatable.) Alternately, the print head may be stationary and the part (or the part support) is movable in the x, y and/or z axes. (The part may also be rotatable.)

A print head may have a feed material in the form of pellets and/or filament and a deposition nozzle. The feed material may be stored in a hopper (for pellets) or other suitable storage vessel nearby to the print head or supplied from a filament spool.

An LFAM apparatus may comprise a nozzle for extruding a material. The polymeric material is heated and extruded through the nozzle and directly deposited on a building surface, which surface may be a movable (or stationary) platform or may also be previously-deposited material. A heat source may be positioned on or in connection with the nozzle to heat the material to a desired temperature and/or flow rate. The platform or bed may be heated, cooled, or left at room temperature.

In one non-limiting embodiment, a nozzle may be configured to extrude molten polymeric material (from melted pellets) at about 10-100 lbs/hr through a nozzle onto a print bed. The size of a print bed may vary depending on the needs of the user and can be room-sized. As one example, a print bed may be sized at about 160×80×34 inches. A LFAM system may have one, two, or more heated zones. A LFAM system may also comprise multiple platforms and even multiple print heads, depending on the user's needs.

One exemplary LFAM method is known as big area additive manufacturing (BAAM; e.g., Cincinnati Incorporated, http://www.e-ci.com/baam/). LFAM systems may utilize filaments, pellets, or both as feed materials. Exemplary description of a BAAM process may be found in, e.g., US2015/0183159, US2015/0183138, US2015/0183164, and U.S. Pat. No. 8,951,303, all of which are incorporated herein by reference in their entireties. The disclosed compositions are also suitable for droplet-based additive manufacturing systems, e.g., the Freeformer™ system by Arburg (https://www.arburg.com/us/us/products-and-services/additive-manufacturing/).

Additive manufacturing systems may use materials in filament form as the build material. Such a system may, as described, effect relative motion between the filament (and/or molten polycarbonate) and a substrate. By applying the molten material according to a pre-set schedule of locations, the system may construct an article in a layer-by-layer fashion, as is familiar to those of ordinary skill in the art. As described elsewhere herein, the build material may also be in pellet form.

Additives

Other additives can be incorporated into the disclosed materials and methods. As an example, one may select one or more additives are selected from at least one of the following: UV stabilizing additives, thermal stabilizing additives, mold release agents, colorants, and gamma-stabilizing agents.

Exemplary antioxidant additives include, for example, organophosphites such as tris(nonyl phenyl)phosphite, tris(2,4-di-t-butylphenyl)phosphite (e.g., “IRGAFOS™ 168” or “I-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of 0.0001 to 1 part by weight, based on 100 parts by weight of the polymer component of the thermoplastic composition (excluding any filler).

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of 0.0001 to 1 part by weight, based on 100 parts by weight of the polymer component of the thermoplastic composition.

Light stabilizers and/or ultraviolet light (UV) absorbing additives can also be used. Exemplary light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of 0.0001 to 1 parts by weight, based on 100 parts by weight of the polymer component of the thermoplastic composition, according to embodiments.

Exemplary UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phe-nol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than or equal to 100 nanometers; or the like, or combinations comprising at least one of the foregoing UV absorbers. UV absorbers are generally used in amounts of 0.0001 to 1 part by weight, based on 100 parts by weight of the polymer component of the thermoplastic composition.

Plasticizers, lubricants, and/or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like. Such materials are generally used in amounts of 0.001 to 1 part by weight, specifically 0.01 to 0.75 part by weight, more specifically 0.1 to 0.5 part by weight, based on 100 parts by weight of the polymer component of the thermoplastic composition.

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT™ 6321 (Sanyo) or PEBAX™ MH1657 (Atofina), IRGASTAT™ P18 and P22 (Ciba-Geigy). Other polymeric materials that can be used as antistatic agents are inherently conducting polymers such as polyaniline (commercially available as PANIPOL™ EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or a combination comprising at least one of the foregoing can be used in a polymeric resin containing chemical antistatic agents to render the composition electrostatically dissipative. Antistatic agents are generally used in amounts of 0.0001 to 5 parts by weight, based on 100 parts by weight (pbw) of the polymer component of the thermoplastic composition.

Colorants such as pigment and/or dye additives can also be present provided they do not adversely affect, for example, any flame retardant performance. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments. Pigments are generally used in amounts of 0.01 to 10 parts by weight, based on 100 parts by weight of the polymer component of the thermoplastic composition.

Exemplary dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly(C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes. Dyes are generally used in amounts of 0.01 to 10 parts by weight, based on 100 parts by weight of the polymer component of the thermoplastic composition.

Anti-drip agents can also be used in the thermoplastic composition according to embodiments, for example a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as, for example, an aromatic polycarbonate or SAN to form an agglomerated material for use as an anti-drip agent. Either method can be used to produce an encapsulated fluoropolymer. Antidrip agents are generally used in amounts of 0.1 to 5 percent by weight, based on 100 parts by weight of the polymer component of the thermoplastic composition.

Radiation stabilizers can also be present, specifically gamma-radiation stabilizers. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-pene-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR⁴HOH or —CR⁴OH wherein R⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl benzyl alcohol. 2-Methyl-2,4-pentanediol, polyethylene glycol, and polypropylene glycol are often used for gamma-radiation stabilization. Gamma-radiation stabilizing compounds are typically used in amounts of 0.1 to 10 parts by weight based on 100 parts by weight of the polymer component of the thermoplastic composition.

### Illustrative Embodiments

To illustrate the improved performance realized by the disclosed technology, several exemplary compositions were tested. The formulations for these illustrative compositions were:

EX1: appx. 80 wt % transparent PC-siloxane co-polymer with M_{w} (weight average) 22,500 to about 23,500 Da measured by gel permeation chromatography and calibrated with polycarbonate standards; appx. 10 wt % end-capped BPA PC with M_{w} (weight average) 29,900 Da measured by gel permeation chromatography and calibrated with polycarbonate standards; appx. 6 wt % end-capped BPA PC with M_{w} (weight average) 21,900 Da measured by gel permeation chromatography and calibrated with polycarbonate standards; balance other additives. EX1 may be transparent in nature. The BPA polycarbonate may have endcaps derived from phenol, paracumyl phenol (PCP), or a combination thereof.

EX2: appx. 40 wt % transparent PC-siloxane co-polymer with M_{w} (weight average) 22,500 to about 23,500 Da measured by gel permeation chromatography and calibrated with polycarbonate standards; appx. 60 wt % end-capped BPA PC with M_{w} (weight average) 29,900 Da measured by gel permeation chromatography and calibrated with polycarbonate standards; balance other additives.

EX3: appx. 90 wt % end-capped PC with M_{w} (weight average) 21,900 measured by gel permeation chromatography and calibrated with polycarbonate standards; appx. 10 wt % end-capped BPA PC with M_{w} (weight average) 29,900 Da measured by gel permeation chromatography and calibrated with polycarbonate standards.

EX4 (commercially available control): Commercially available PC filament.

EX5: appx. 22 wt % opaque PC-siloxane co-polymer with M_{w} (weight average) 28,000 to about 32,000 Da measured by gel permeation chromatography and calibrated with polycarbonate standards; appx. 38.5 wt % end-capped PC with M_{w} (weight average) 29,900 Da measured by gel permeation chromatography and calibrated with polycarbonate standards; appx. 38.5 wt % end-capped PC with M_{w} (weight average) 21,900 Da measured by gel permeation chromatography and calibrated with polycarbonate standards; balance other additives. (EX5 was opaque in nature.)

For the comparative testing shown below, PC/PC-siloxane copolymer compositions EX1, EX2, and EX5 were extruded into monofilament form and were then used to print tensile, flex and Izod bars by an FFF process. The parts were then tested according to ASTM test protocols (D638, D 256). The data from EX1, EX2, and EX5 was compared to a commercially available PC (EX4) for FFF.

The parts were printed at standard PC extrusion and oven temperatures, using a Stratasys Fortus 400 mc™ or 900 mc™ machine, under the following conditions: standard/default PC conditions; model temp (345 deg. C) and oven temp (140-145 deg. C); tip size: 0.010″ (T16); layer thickness (resolution): 0.010″ (T16); contour and raster width: 0.020″; approximate speed: 12 in/sec. FIG. 1—described elsewhere herein—provides an illustration of layer alignment in exemplary printed articles, and FIG. 2 provides an illustration of layer construction in an exemplary additive manufacturing system.

The properties of the monofilaments used in printing are shown below in Table 1, i.e., the commercially available control EX4, and the EX1, EX2, and EX5 samples.

The glass transition temperature (Tg) and specific gravity were similar for all grades, but EX1 exhibited a lower melt flow compared to the other two samples.

TABLE 1
Properties of exemplary EX4 (control), EX1, EX2, and EX5 filaments

| Filament | | | | | |
|---|---|---|---|---|---|
| Properties | Units | EX4 | EX2 | EX1 | EX5 |
| MFR - | g/10 min | 27 | 29 | 10 | 10 |
| 300° C., | | | | | |
| 1.2 kg, 360 s | | | | | |
| DSC - Tg | ° C. | 147 | 146 | 147 | 146 |
| GPC - Mw | Da | 22350 | 20882 | 24561 | 26793 |
| Specific | — | 1.197 | 1.196 | 1.19 | |
| Gravity | | | | | |

The mechanical properties (tensile modulus, strength, and elongation, flexural modulus, notched and un-notched Izod impact) of printed parts made with the exemplary compositions are shown in Table 2. The orientation of the printed parts is noted as flat, on edge, or upright, which corresponds to the XY, XZ, or ZX axis directions, respectively, as depicted in FIG. 1.

The injection molding datasheet values for EX2 and EX3 are also are included in Table 2 below for reference.

TABLE 2
Mechanical properties of printed parts

| | EX3 | EX2 | | | | EX4 | | | EX1 | | | EX5 | | |
|---|---|---|---|---|---|---|---|---|---|---|---|---|---|---|
| | Data | Data | | On- | Up- | | On- | Up- | | On- | Up- | | On- | Up- |
| Test/Units | sheet | sheet | Flat | edge | right | Flat | Edge | right | Flat | Edge | right | Flat | Edge | right |
| Notched | 640 | 702 | 273 | 126 | 35 | 47 | 45 | 30 | 204 | 297 | 57 | 252 | 248 | 71 |
| Izod | | | | | | | | | | | | | | |
| Impact | | | | | | | | | | | | | | |
| (J/m) | | | | | | | | | | | | | | |
| ASTM | | | | | | | | | | | | | | |
| D256 | | | | | | | | | | | | | | |
| Un- | — | — | 1100 | 1310 | 109 | 354 | 564 | 141 | 832 | 695 | 226 | 961 | 529 | 233 |
| Notched | | | | | | | | | | | | | | |
| Izod | | | | | | | | | | | | | | |
| Impact | | | | | | | | | | | | | | |
| (J/m) | | | | | | | | | | | | | | |
| ASTM | | | | | | | | | | | | | | |
| D256 | | | | | | | | | | | | | | |
| Tensile | — | 2360 | 1974 | 1956 | 1968 | 2062 | 2196 | 1992 | 1776 | 1921 | 1770 | 1633 | 2016 | 1738 |
| Modulus | | | | | | | | | | | | | | |
| (MPa) | | | | | | | | | | | | | | |
| ASTM | | | | | | | | | | | | | | |
| D638 | | | | | | | | | | | | | | |
| Tensile | 65 | 58 | 51 | 54 | 45 | 54 | 65 | 45 | 46 | 53 | 38 | 40 | 49 | 40 |
| Strength | | | | | | | | | | | | | | |
| at Break | | | | | | | | | | | | | | |
| (MPa) | | | | | | | | | | | | | | |
| ASTM | | | | | | | | | | | | | | |
| D638 | | | | | | | | | | | | | | |
| Elongation | 120 | 119 | 6 | 5 | 3 | 6 | 6 | 3 | 6 | 5 | 3 | 6 | 4 | 3 |
| at | | | | | | | | | | | | | | |
| Break (%) | | | | | | | | | | | | | | |
| ASTM | | | | | | | | | | | | | | |
| D638 | | | | | | | | | | | | | | |
| Flexural | 2300 | 2350 | 1810 | 1980 | 1760 | 1810 | 2190 | 1850 | 1475 | 1955 | 1571 | 1440 | 1960 | 1540 |
| Modulus | | | | | | | | | | | | | | |
| (MPa) | | | | | | | | | | | | | | |
| ASTM | | | | | | | | | | | | | | |
| D790 | | | | | | | | | | | | | | |

As shown in Table 2 above, EX1, EX2, and EX5 show a significant improvement in Izod impact properties over EX4. Without being bound to any particular theory, this may be at least partially due to the siloxane content of the EX1, EX2, and EX5 copolymers.

Depending at least somewhat on FFF print orientation, the notched Izod impact strength of EX1 and EX5 improved by 190-660% over EX4 (see Table 3). This significant improvement makes available to users a variety of applications that require higher impact strength in 3D printed parts, e.g., applications that require high impact strength and ductility, such as mobile phones, helmets, automotive, outdoor electrical enclosures, and medical devices.

The un-notched Izod impact property retention compared to EX4 varied depending on orientation. All orientations of EX1 and flat and upright orientations for EX5 had improved impact strength over EX4 (see Table 3).

In some illustrative, non-limiting embodiments, at least 70% of tensile and flexural properties were maintained compared to EX4. In some cases, 80-100% of these properties were maintained (see Table 3).

TABLE 3
Mechanical properties of EX1 and EX5 grades compared to EX4

| | EX1 | | | EX5 | | |
|---|---|---|---|---|---|---|
| | | On- | | | On- | |
| Test/Units | Flat | Edge | Upright | Flat | Edge | Upright |
| Notched Izod | 434% | 660% | 190% | 536% | 551% | 237% |
| Impact (J/m) | | | | | | |
| Un-Notched Izod | 235% | 123% | 160% | 271% | 94% | 165% |
| Impact (J/m) | | | | | | |
| Tensile Modulus (MPa) | 86% | 87% | 89% | 79% | 92% | 87% |
| Tensile Strength at | 85% | 118% | 70% | 62% | 109% | 87% |
| Break (MPa) | | | | | | |
| Elongation at Break (%) | 100% | 83% | 100% | 100% | 67% | 100% |
| Flexural Modulus (MPa) | 81% | 89% | 85% | 80% | 89% | 83% |

As shown above, the EX1 and EX5 notched and un-notched Izod impact strength is significantly (2-7 times) higher than standard PC (EX4) in all orientations. The EX1 and EX5 tensile and flexural properties are slightly lower than EX4 (as expected due to siloxane content), but are still comparable.

Table 4 below provides low-temperature impact strength for EX4, EX1, and EX5 formulations:

TABLE 4
Selected mechanical properties for test samples

| | | EX4 | | | EX1 | | | EX5 | | |
|---|---|---|---|---|---|---|---|---|---|---|
| | | | On- | Up- | | On- | Up- | | On- | Up- |
| | Units | Flat | Edge | right | Flat | Edge | right | Flat | Edge | right |
| Notched Izod | J/m | 47 | 45 | 30 | 204 | 297 | 57 | 252 | 248 | 71 |
| Impact, 23° C. | | | | | | | | | | |
| Un-Notched | J/m | 354 | 564 | 141 | 832 | 695 | 226 | 961 | 529 | 233 |
| Izod Impact, 23° C. | | | | | | | | | | |
| Notched Izod | J/m | | | | 205 | 292 | 34 | 242 | 251 | 62 |
| Impact, 0° C. | | | | | | | | | | |
| Un-Notched | J/m | | | | 900 | 691 | 213 | 863 | 552 | 236 |
| Izod Impact, 0° C. | | | | | | | | | | |
| Notched Izod | J/m | | | | 196 | 298 | 37 | 213 | 249 | 64 |
| Impact, −10° C. | | | | | | | | | | |
| Un-Notched | J/m | | | | 880 | 667 | 200 | 955 | 560 | 237 |
| Izod Impact, −10° C. | | | | | | | | | | |
| Notched Izod | J/m | | | | 202 | 287 | 38 | 220 | 255 | 50 |
| Impact, −20° C. | | | | | | | | | | |
| Un-Notched | J/m | | | | 916 | 737 | 224 | 902 | 578 | 238 |
| Izod Impact, −20° C. | | | | | | | | | | |
| Notched Izod | J/m | | | | 196 | 276 | 38 | 213 | 236 | 47 |
| Impact, −30° C. | | | | | | | | | | |
| Un-Notched | J/m | | | | 906 | 712 | 214 | 960 | 562 | 249 |
| Izod Impact, −30° C. | | | | | | | | | | |
| Notched Izod | J/m | | | | 191 | 240 | 42 | 213 | 236 | 47 |
| Impact, −40° C. | | | | | | | | | | |
| Un-Notched | J/m | | | | 979 | 869 | 203 | 959 | 576 | 272 |
| Izod Impact, −40° C. | | | | | | | | | | |

As shown above, EX1 and EX5 parts maintain higher notched and un-notched Izod impact strength than standard PC (EX4) in all print orientations at temperatures down to −40° C. (All data were obtained according to ASTM D256.)

Multi-axial impact testing was also performed, as shown by Table 5 below.

TABLE 5
Multi-axial impact testing

| | | EX4 | | EX1 | | EX5 | |
|---|---|---|---|---|---|---|---|
| ASTM | | | On- | | On- | | On- |
| D3763: 23° C., | | | Edge/ | | Edge/ | | Edge/ |
| 3.3 m/s | Units | Flat | Upright | Flat | Upright | Flat | Upright |
| Energy to | J | 3.0 | 1.7 | 12.7 | 16.0 | 12.5 | 15.7 |
| failure-Avg | | | | | | | |
| Energy, | J | 3.3 | 3.1 | 13.0 | 16.9 | 12.9 | 16.4 |
| Total-Avg | | | | | | | |

As shown in the table above, EX1 and EX5 have about 4 to about 10 times greater higher energy to failure and total energy compared to EX4 in multi-axial impact testing. Additionally, PC (EX4) samples were found to be more brittle than EX1 and EX5, as EX4 samples failed by fast crack propagation and breaking (evidenced by a comparatively large hole in the center of each test disk of EX4 material, with the test disk breaking into smaller pieces), while EX1 and EX5 sample disks had some deformation and slower crack propagation (greater ductility), leaving those samples comparatively more intact after impact testing.

As discussed elsewhere herein, the disclosed technology represents a “drop-in” improvement for additive manufacturing processes. The disclosed methods are easily substituted for existing approaches in additive manufacturing systems, and the disclosed methods enable users to adopt them to achieve immediate improvement in the mechanical properties of additive-manufactured parts.

1-20. (canceled)

21. A polymeric composition for additive manufacturing, comprising:
an amount of a polycarbonate composition comprising:
(a) a BPA-polycarbonate, the BPA-polycarbonate having a molecular weight (weight average) from 16,000 to 35,000 Daltons measured by gel permeation chromatography and calibrated with polycarbonate standards; and
(b) (i) a BPA-polycarbonate-siloxane block copolymer having a molecular weight (weight average) of from 28,000 to 32,000 Daltons measured by gel permeation chromatography and calibrated with polycarbonate standards, or (ii) a BPA-polycarbonate-siloxane block copolymer having a molecular weight (weight average) of from 22,500 to 23,500 Daltons measured by gel permeation chromatography and calibrated with polycarbonate standards, or both (i) and
wherein the composition is in the form of a filament, the filament having a length of at least 1 cm, and the standard deviation of the filament's diameter along 0.5 cm of the length is less than 0.1 mm.

22. The polymeric composition of claim 21, wherein the polymeric composition comprises 5-85 wt % BPA-polycarbonate-siloxane block copolymer in the BPA-polycarbonate composition.

23. The polymeric composition of claim 21, wherein the BPA-polycarbonate-siloxane block copolymer has a molecular weight (weight average) of from 28,000 to 32,000 Daltons measured by gel permeation chromatography and calibrated with polycarbonate standards and the polymeric composition comprises from 10 to 40 wt % of the BPA-polycarbonate-siloxane block copolymer based on the combined weights of the BPA-polycarbonate (a) and BPA-polycarbonate-siloxane block copolymer (b) in the polycarbonate composition.

24. The polymeric composition of claim 23, wherein the BPA-polycarbonate-siloxane block copolymer has a molecular weight (weight average) of from 28,000 to 32,000 Daltons measured by gel permeation chromatography and calibrated with polycarbonate standards and the polymeric composition comprises from 15 to 25 wt % of the BPA-polycarbonate-siloxane block copolymer based on the combined weight of the BPA-polycarbonate (a) and BPA-polycarbonate-siloxane block copolymer (b) in the polycarbonate composition.

25. The polymeric composition of claim 21, wherein the BPA-polycarbonate-siloxane block copolymer has a molecular weight (weight average) of from 22,500 to 23,500 Daltons measured by gel permeation chromatography and calibrated with polycarbonate standards and the polymeric composition comprises 530-90 wt % of the BPA-polycarbonate-siloxane block copolymer based on the combined weight of the BPA-polycarbonate (a) and BPA-polycarbonate-siloxane block copolymer (b) in the polycarbonate composition.

26. The polymeric composition of claim 21, wherein the weight of the polysiloxane is from 1 to 7 wt % of the polycarbonate composition.

27. An additively-manufactured article, comprising:
a plurality of layers of a polycarbonate composition, wherein the polycarbonate composition comprises:
(a) a BPA-polycarbonate having a molecular weight (weight average) in the range of from 16,000 to 35,000 Daltons measured by gel permeation chromatography and calibrated with polycarbonate standards; and
(b)(i) a BPA-polycarbonate-siloxane block copolymer having a molecular weight (weight average) of from 28,000 to 32,000 Daltons measured by gel permeation chromatography and calibrated with polycarbonate standards, or (ii) a BPA-polycarbonate-siloxane block copolymer having a molecular weight (weight average) of from 22,500 to 23,500 Daltons measured by gel permeation chromatography and calibrated with polycarbonate standards, or both (i) and (ii).

28. The additively-manufactured article of claim 27, wherein the polycarbonate composition comprises from 5-85 wt % of the BPA-polycarbonate-siloxane block copolymer based on the weight of the BPA-polycarbonate and BPA-polycarbonate-siloxane block copolymer in the BPA-polycarbonate composition.

29. The additively-manufactured article of claim 27, wherein the BPA-polycarbonate-siloxane block copolymer has a Mw (weight average) of from 28,000 to 32,000 Daltons measured by gel permeation chromatography and calibrated with polycarbonate standards and the polycarbonate composition comprises from 10 to 40 wt % of the BPA-polycarbonate-siloxane block copolymer based on the combined weights of the BPA-polycarbonate (a) and BPA-polycarbonate-siloxane block copolymer (b) in the polycarbonate composition.

30. The additively-manufactured article of claim 27, wherein the BPA-polycarbonate-siloxane block copolymer has a Mw (weight average) of from 28,000 to 32,000 Daltons measured by gel permeation chromatography and calibrated with polycarbonate standards and the polycarbonate composition comprises from 15 to 25 wt % of the BPA-polycarbonate-siloxane block copolymer based on the combined weight of the BPA-polycarbonate (a) and BPA-polycarbonate-siloxane block copolymer (b) in the polycarbonate composition.

31. The additively-manufactured article of claim 27, wherein the BPA-polycarbonate-siloxane block copolymer has a Mw (weight average) of from 22,500 to 23,500 Daltons measured by gel permeation chromatography and calibrated with polycarbonate standards and the polycarbonate composition comprises from 30-90 wt % of the BPA-polycarbonate-siloxane block copolymer based on the combined weight of the BPA-polycarbonate (a) and BPA-polycarbonate-siloxane block copolymer (b) in the polycarbonate composition.

32. The additively-manufactured article of claim 27, wherein the weight of the polysiloxane is from 1 to 7 wt % of the polycarbonate composition.

33. The polymeric composition of claim 21, wherein the polymeric composition has
(a) a Notched Izod Impact Strength measured at −40° C. that is within 20% of the Notched Izod Impact Strength measured at 23° C., or
(b) an Un-Notched Izod Impact Strength measured at −40° C. that is within 30% of the Un-Notched Izod Impact Strength measured at 23° C., or
(c) a Notched Izod Impact Strength measured at 23 deg. C) that is from 1.5 times to 10 times the Notched Izod Impact Strength measured at 23° C. of a BPA-polycarbonate that comprises 90 wt % end-capped PC with a molecular weight (weight average) of 21,900 Daltons and 10 wt % end-capped BPA-polycarbonate with a molecular weight (weight average) of 29,900 Daltons, or (d) an Un-Notched Izod Impact Strength measured at 23° C. that is from 1.5 times to 10 times the Un-Notched Izod Impact Strength measured at 23° C. (ASTM D256) of a BPA-polycarbonate that comprises 90 wt % end-capped PC with a molecular weight (weight average) of 21,900 Daltons and 10 wt % end-capped BPA-polycarbonate with a molecular weight (weight average) of 29,900 Daltons, or
any combination of (a), (b), (c), and (d),
(a), (b), (c), and (d) being measured on parts printed by fused filament fabrication in an on-edge (XZ) print orientation under nominal conditions and measured using the ASTM D256 test protocol.

34. The polymeric composition of claim 21, wherein the polymeric composition is characterized as having a total multi-axial impact energy that is from 1.5 times to 10 times the multi-axial impact energy of a BPA-polycarbonate that comprises 90 wt % end-capped BPA-polycarbonate with a Mw (weight average) of 21,900 Daltons and 10 wt % end-capped BPA-polycarbonate with a Mw (weight average) of 29,900 Daltons, the multi-axial impact energy being measured on parts printed by fused filament fabrication in a flat (XY) orientation under nominal conditions and measured using ASTM D3763 test protocol, 23 deg. C., 3.3 m/s, 3.2 mm thickness.

35. A method, comprising additively manufacturing an article using the polymeric composition of claim 21.

36. The method of claim 35, wherein the amount of the polycarbonate composition is in filament form.

37. The method of claim 35, wherein the amount of the polycarbonate composition is in pellet form.

38. A system, comprising:
a dispenser having disposed within an amount of the polymeric composition of claim 21; and
a substrate,
one or both of the dispenser and substrate being capable of controllable motion relative to the other.
